(19) United States
(12) Patent Application Publication
(10) Pub. No.: US 2012/0056982 A1
(43) Pub. Date: Mar. 8, 2012

(54) DEPTH CAMERA BASED ON STRUCTURED LIGHT AND STEREO VISION

(75) Inventors: Sagi Katz, Yokneam Ilit (IL); Avishai Adler, Haifa (IL)

(73) Assignee: MICROSOFT CORPORATION, Redmond, WA (US)

(21) Appl. No.: 12/877,595

(22) Filed: Sep. 8, 2010

(51) Int. Cl. H04N 13/02

(52) U.S. Cl. 348/43; 348/47; 348/E13.074

(57) ABSTRACT

A depth camera system uses a structured light illuminator and multiple sensors such as infrared light detectors, such as in a system which tracks the Motion of a user in a field of view. One sensor can be optimized for shorter range detection while another sensor is optimized for longer range detection. The sensors can have a different baseline distance from the illuminator, as well as a different spatial resolution, exposure time and sensitivity. In one approach, depth values are obtained from each sensor by matching to the structured light pattern, and the depth values are merged to obtain a final depth map which is provided as an input to an application. The merging can involve unweighted averaging, weighted averaging, accuracy measures and/or confidence measures. In another approach, additional depth values which are included in the merging are obtained using stereoscopic matching among pixel data of the sensors.

### BACKGROUND

A real-time depth camera is able to determine the distance to a human or other object in a field of View of the camera, and to update the distance substantially in real time based on a frame rate of the camera. Such a depth camera can be used in motion capture systems, for instance, to obtain data regarding the location and movement of a human body or other subject in a physical space, and can use the data as an input to an application in a computing system. Many applications are possible, such as for military, entertainment, sports and medical purposes. Typically, the depth camera includes an illuminator which illuminates the field of view, and an image sensor which senses light from the field of view to forth an image. However, various challenges exist due to variables such as lighting conditions, surface textures and colors, and the potential for occlusions.

### SUMMARY

A depth camera system is provided. The depth camera system uses at least two image sensors, and a combination of structured light image processing and stereoscopic image processing to obtain a depth map of a scene in substantially real time. The depth map can be updated for each new frame of pixel data which is acquired by the sensors. Furthermore, the image sensors can be mounted at different distances from an illuminator, and can have different characteristics, to allow a more accurate depth map to be obtained while reducing the likelihood of occlusions.

In one embodiment, a depth camera system includes an illuminator which illuminates an object in a field of view with a pattern of structured light, at least first and second sensors, and at least one control circuit. The first sensor senses reflected light from the object to obtain a first frame of pixel data, and is optimized for shorter range imaging. This optimization can be realized in terms of, e.g., a relatively shorter distance between the first sensor and the illuminator, or a relatively small exposure time, spatial resolution and/or sensitivity to light of the first sensor. The depth camera system further includes a second sensor which senses reflected light from the object to obtain a second frame of pixel data, where the second sensor is optimized for longer range imaging. This optimization can be realized in terms of, e.g., a relatively longer distance between the second sensor and the illuminator, or a relatively large exposure time, spatial resolution and/or sensitivity to light of the second sensor.

The depth camera system further includes at least one control circuit, which can be in a common housing with the sensors and illuminators, and/or in a separate component such as a computing environment. The at least one control circuit derives a first structured light depth map of the object by comparing the first frame of pixel data to the pattern of the structured light, derives a second structured light depth map of the object by comparing the second frame of pixel data to the pattern of the structured light, and derives a merged depth map which is based on the first and second structured light depth maps. Each depth map can include a depth value for each pixel location, such as in a grid of pixels.

In another aspect, stereoscopic image processing is also used to refine depth values. The use of stereoscopic image processing may be triggered when one or more pixels of the first and/or second frames of pixel data are not successfully matched to a pattern of structured light, or when a depth value indicates a large distance that requires a larger base line to achieve good accuracy, for instance. In this manner, further refinement is provided to the depth values only as needed, to avoid unnecessary processing steps.

In some cases, the depth data obtained by a sensor can be assigned weights based on characteristics of the sensor, and/or accuracy measures based on a degree of confidence in depth values.

The final depth map can be used an input to an application in a motion capture system, for instance, where the object is a human which is tracked by the motion capture system, and where the application changes a display of the motion capture system in response to a gesture or movement by the human, such as by animating an avatar, navigating an on-screen menu, or performing some other action.

This summary is provided to introduce a selection of concepts in a simplified form that are further described below in the description. This summary is not intended to identify key features or essential features of the claimed subject matter, nor is it intended to be used to limit the scope of the claimed subject matter.

### BRIEF DESCRIPTION OF THE DRAWINGS

In the drawings, like-numbered elements correspond to one another.

FIG. 1 depicts an example embodiment of a motion capture system.

FIG. 2 depicts an example block diagram of the motion capture system of FIG. 1.

FIG. 3 depicts an example block diagram of a computing environment that may be used in the motion capture system of FIG. 1.

FIG. 4 depicts another example block diagram of a computing environment that may be used in the motion capture system of FIG. 1.

FIG. 5A depicts an illumination frame and a captured frame in a structured light system.

FIG. 5B depicts two captured frames in a stereoscopic light system.

FIG. 6A depicts an imaging component having two sensors on a common side of an illuminator.

FIG. 6B depicts an imaging component having two sensors on one side of an illuminator, and one sensor on an opposite side of the illuminator.

FIG. 6C depicts an imaging component having three sensors on a common side of an illuminator.

FIG. 6D depicts an imaging component having two sensors on opposing sides of an illuminator, showing how the two sensors sense different portions of an object.

FIG. 7A depicts a process for obtaining a depth map of a field of view.

FIG. 7B depicts further details of step 706 of FIG. 7A, in which two structured light depth maps are merged.

FIG. 7C depicts further details of step 706 of FIG. 7A, in which two structured light depth maps and two stereoscopic depth maps are merged.

FIG. 7D depicts further details of step 706 of FIG. 7A, in which depth values are refined as needed using stereoscopic matching.

FIG. 7E depicts further details of another approach to step 706 of FIG. 7A, in which depth values of a merged depth map are refined as needed using stereoscopic matching.

FIG. 8 depicts an example method for tracking a human target using a control input as set forth in step 708 of FIG. 7A.

FIG. 9 depicts an example model of a. human target as set forth in step 808 of FIG. 8.

### DETAILED DESCRIPTION

A depth camera is provided for use in tracking one or more objects in a field of view. In an example implementation, the depth camera is used in a motion tracking system to track a human user. The depth camera includes two or more sensors which are optimized to address variables such as lighting conditions, surface textures and colors, and the potential for occlusions. The optimization can include optimizing placement of the sensors relative to one another and relative to an illuminator, as well as optimizing spatial resolution, sensitivity and exposure time of the sensors. The optimization can also include optimizing how depth map data is obtained, such as by matching a frame of pixel data to a pattern of structured light and/or by matching a frame of pixel data to another frame.

The use of multiple sensors as described herein provides advantages over other approaches. For example, real-time depth cameras, other than stereo cameras, tend to provide a depth map that is embeddable on a 2-D matrix. Such cameras are sometimes referred to as 2.5D cameras since they usually use a single imaging device to extract a depth map, so that no information is given for occluded objects. Stereo depth cameras tend to obtain rather sparse measurements of locations that are visible to two or more sensors. Also, they do not operate well when imaging smooth textureless surfaces, such as a white wall. Some depth cameras use structured light to measure/identify the distortion created by the parallax between the sensor as an imaging device and the illuminator as a light projecting device that is distant from it. This approach inherently produces a depth map with missing information due to shadowed locations that are visible to the sensor, but are not visible to the illuminator. In addition, external light can sometimes make the structured patterns invisible to the camera.

The above mentioned disadvantages can be overcome by using a constellation of two or more sensors with a single illumination device to effectively extract 3D samples as if three depth cameras were used. The two sensors can provide depth data by matching to a structured light pattern, while the third camera is achieved by matching the two images from the two sensors by applying stereo technology. By applying data fusion, it is possible to enhance the robustness of the 3D measurements, including robustness to inter-camera disruptions. We provide the usage of two sensors with a single projector to achieve two depth maps, using structured light technology, combining of structured light technology with stereo technology, and using the above in a fusion process to achieve a 3D image with reduced occlusions and enhanced robustness.

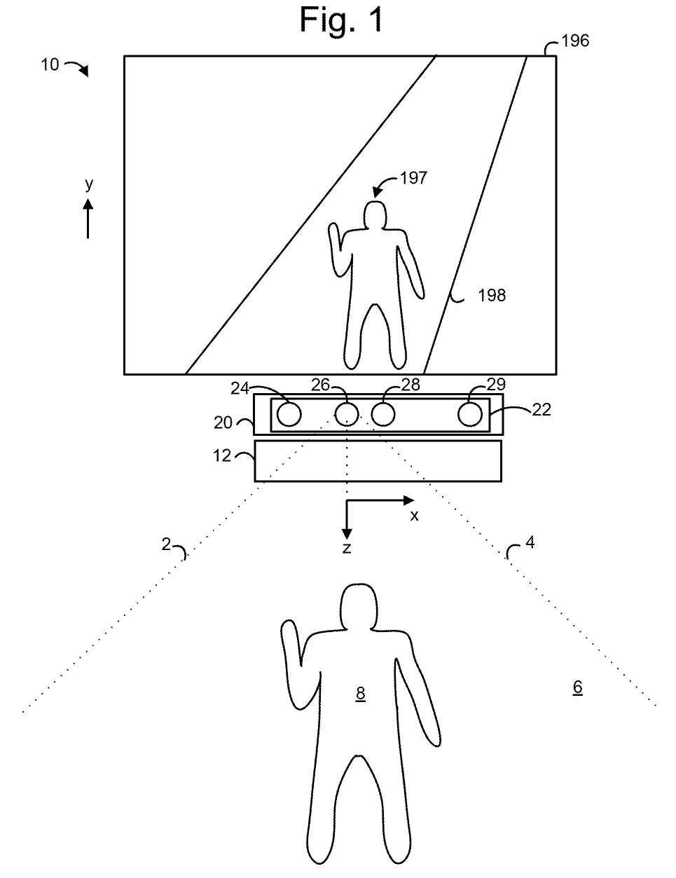

FIG. 1 depicts an example embodiment of a motion capture system 10 in which a human 8 interacts with an application, such as in the home of a user. The motion capture system 10 includes a display 196, a depth camera system 20, and a computing environment or apparatus 12. The depth camera system 20 may include an imaging component 22 having an illuminator 26, such as an infrared (IR) light emitter, an image sensor 26, such as an infrared camera, and a color (such as a red-green-blue RGB) camera 28. One or more objects such as a human 8, also referred to as a user, person or player, stands in a field of view 6 of the depth camera. Lines 2 and 4 denote a boundary of the field of view 6. In this example, the depth camera system 20, and computing environment 12 provide an application in which an avatar 197 on the display 196 track the movements of the human 8. For example, the avatar may raise an arm when the human raises an arm. The avatar 197 is standing on a road 198 in a 3-D virtual world. A Cartesian world coordinate system may be defined which includes a z-axis which extends along the focal length of the depth camera system 20, e.g., horizontally, a y-axis which extends vertically, and an x-axis which extends laterally and horizontally. Note that the perspective of the drawing is modified as a simplification, as the display 196 extends vertically in the y-axis direction and the z-axis extends out from the depth camera system, perpendicular to the y-axis and the x-axis, and parallel to a ground surface on which the user 8 stands.

Generally, the motion capture system 10 is used to recognize, analyze, and/or track one or more human targets. The computing environment 12 can include a computer, a gaming system or console, or the like, as well as hardware components and/or software components to execute applications.

The depth camera system 20 may be used to visually monitor one or more people, such as the human 8, such that gestures and/or movements performed by the human may be captured, analyzed, and tracked to perform one or more controls or actions within an application, such as animating an avatar or on-screen character or selecting a menu item in a user interface (UI). The depth camera system 20 is discussed in further detail below.

The motion capture system 10 may be connected to an audiovisual device such as the display 196, e.g., a television, a monitor, a high-definition television (HDTV), or the like, or even a projection on a wall or other surface that provides a visual and audio output to the user. An audio output can also be provided via a separate device. To drive the display, the computing environment 12 may include a video adapter such as a graphics card and/or an audio adapter such as a sound card that provides audiovisual signals associated with an application. The display 196 may be connected to the computing environment 12.

The human 8 may be tracked using the depth camera system 20 such that the gestures and/or movements of the user are captured and used to animate an avatar or on-screen character and/or interpreted as input controls to the application being executed by computer environment 12.

Some movements of the human 8 may be interpreted as controls that may correspond to actions other than controlling an avatar. For example, in one embodiment, the player may use movements to end, pause, or save a game, select a level, view high scores, communicate with a friend, and so forth. The player may use movements to select the game or other application from a main user interface, or to otherwise navigate a menu of options. Thus, a full range of motion of the human 8 may be available, used, and analyzed in any suitable manner to interact with an application.

The motion capture system 10 may further be used to interpret target movements as operating system and/or application controls that are outside the realm of games and other applications which are meant for entertainment and leisure. For example, virtually any controllable aspect of an operating system and/or application may be controlled by movements of the human 8.

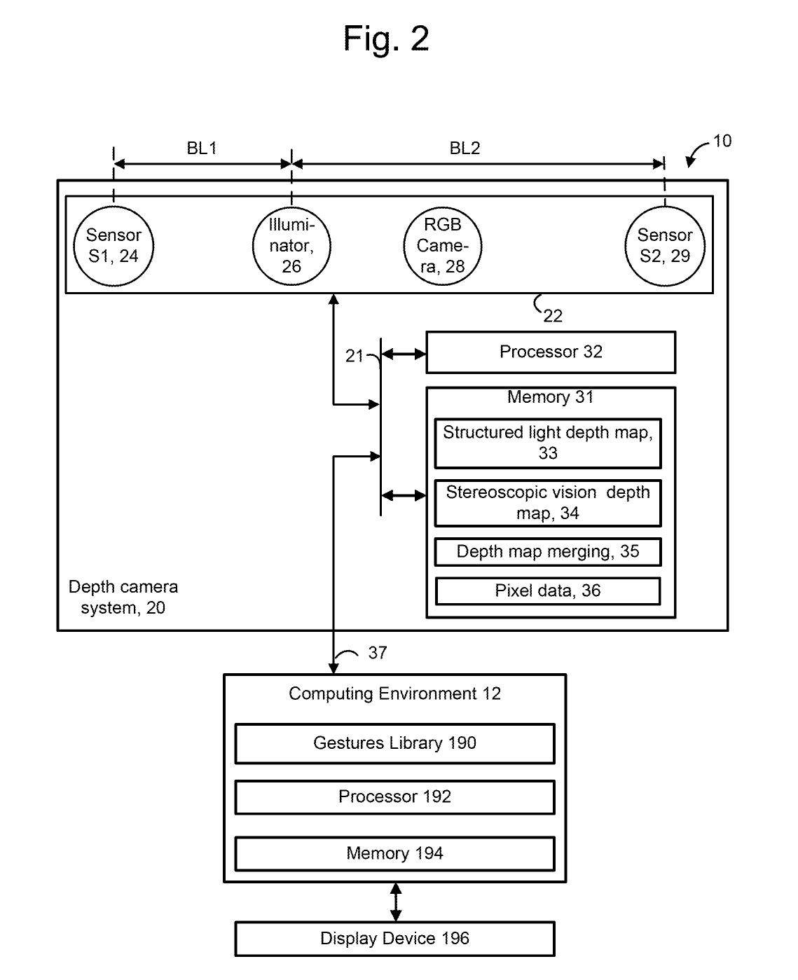

FIG. 2 depicts an example block diagram of the motion capture system 10 of FIG. 1a. The depth camera system 20 may be configured to capture video with depth information including a depth image that may include depth values, via any suitable technique including, for example, time-of-flight, structured light, stereo image, or the like. The depth camera System 20 may organize the depth information into “Z layers,” or layers that may be perpendicular to a Z axis extending from the depth camera along its line of sight.

The depth camera system 20 may include an imaging component 22 that captures the depth image of a scene in a physical space. A depth image or depth map may include a two-dimensional (2-D) pixel area of the-captured scene, where each pixel in the 2-D pixel area has an associated depth value which represents a linear distance from the imaging component 22 to the object, thereby providing a 3-D depth image.

Various configurations of the imaging component 22 are possible. In one approach, the imaging component 22 includes an illuminator 26, a first image sensor (S1) 24, a second image sensor (S2) 29, and a visible color camera 28. The sensors S1 and S2 can be used to capture the depth image of a scene. In one approach, the illuminator 26 is an infrared (IR) light emitter, and the first and second sensors are infrared light sensors. A 3-D depth camera is formed by the combination of the illuminator 26 and the one or more sensors.

A depth map can be obtained by each sensor using various techniques. For example, the depth camera system 20 may use a structured light to capture depth information. In such an analysis, patterned light (i.e., light displayed as a known pattern such as grid pattern or a stripe pattern) is projected onto the scene by the illuminator 26. Upon striking the surface of one or more targets or objects in the scene, the pattern may become deformed in response. Such a deformation of the pattern may be captured by, for example, the sensors 24 or 29 and/or the color camera 28 and may then be analyzed to determine a physical distance from the depth camera system to a particular location on the targets or objects.

In one possible approach, the sensors 24 and 29 are located on opposite sides of the illuminator 26, and at different baseline distances from the illuminator. For example, the sensor 24 is located at a distance BL1 from the illuminator 26, and the sensor 29 is located at a distance BL2 from the illuminator 26. The distance between a sensor and the illuminator may be expressed in terms of a distance between central points, such as optical axes, of the sensor and the illuminator. One advantage of having sensors on opposing sides of an illuminator is that occluded areas of an object in a field of view can be reduced or eliminated since the sensors see the object from different perspectives. Also, a sensor can be optimized for viewing objects which are closer in the field of view by placing the sensor relatively closer to the illuminator, while another sensor can be optimized for viewing objects which are further in the field of view by placing the sensor relatively further from the illuminator. For example, with BL2>BL1, the sensor 24 can be considered to be optimized for shorter range imaging while the sensor 29 can be considered to be optimized for longer range imaging. In one approach, the sensors 24 and 29 can be collinear, such that they placed along a common line which passes through the illuminator. However, other configurations regarding the positioning of the sensors 24 and 29 are possible.

For example, the sensors could be arranged circumferentially around an object which is to be scanned, or around a location in which a hologram is to be projected. It is also possible to arrange multiple depth cameras systems, each with an illuminator and sensors, around an object. This can allow viewing of different sides of an object, providing a rotating view around the object. By using more depth cameras, we add more visible regions of the object. One could have two depth cameras, one in the front and one in the back of an object, aiming at each other, as long as they do not blind each other with their illumination. Each depth camera can sense its own structured light pattern which reflects from the object. In another example, two depth cameras are arranged at 90 degrees to each other.

The depth camera system 20 may include a processor 32 that is in communication with the 3-D depth camera 22. The processor 32 may include a standardized processor, a specialized processor, a microprocessor, or the like that may execute instructions including, for example, instructions for receiving a depth image; generating a grid of voxels based on the depth image; removing a background included in the grid of voxels to isolate one or more voxels associated with a human target; determining a location or position of one or more extremities of the isolated human target; adjusting a model based on the location or position of the one or more extremities, or any other suitable instruction, which will be described in more detail below.

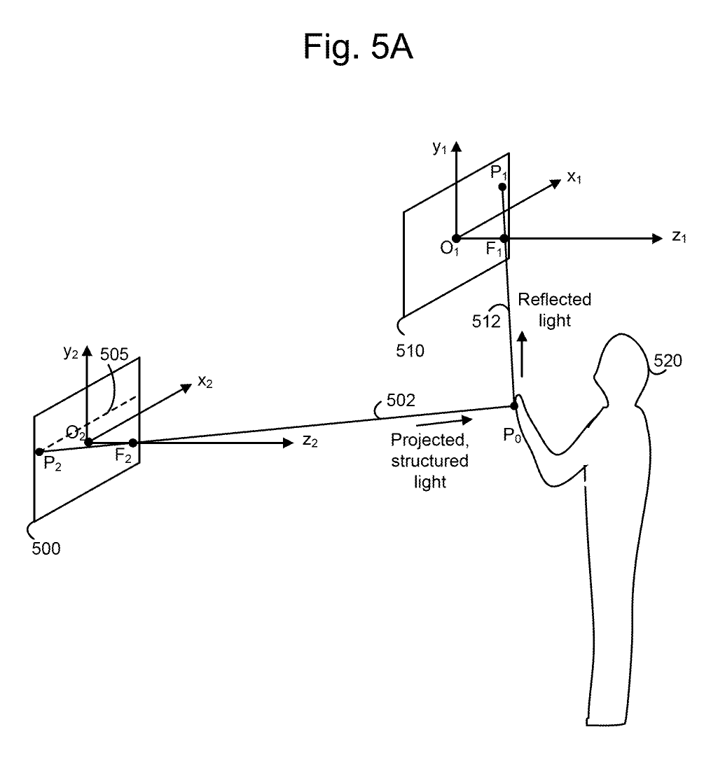

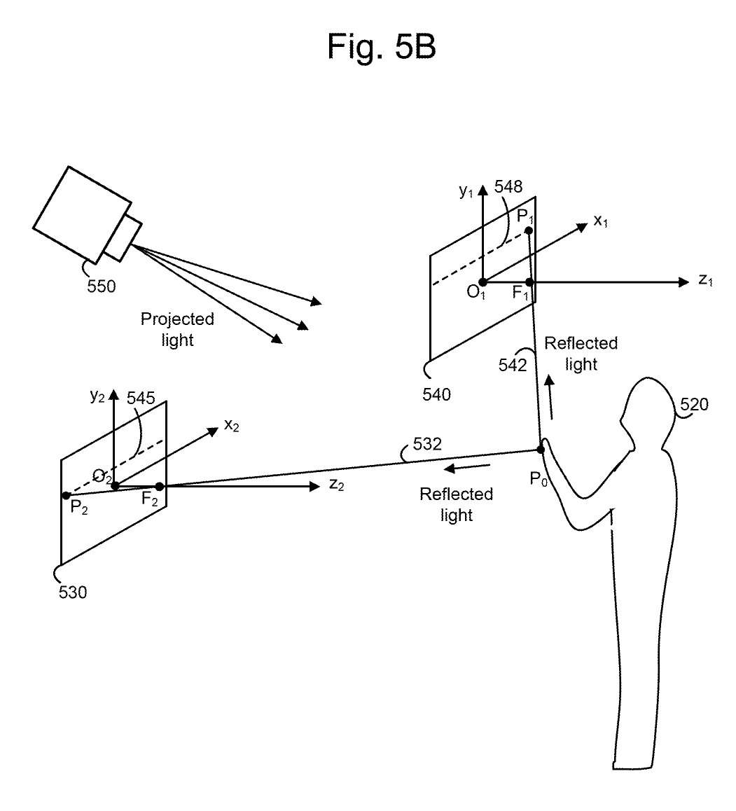

The processor 32 can access a memory 31 to use software 33 which derives a structured light depth map, software 34 which derives a stereoscopic vision depth map, and software 35 which performs depth map merging calculations. The processor 32 can be considered to be at least one control circuit which derives a structured light depth map of an object by comparing a frame of pixel data to a pattern of the structured light which is emitted by the illuminator in an illumination plane. For example, using the software 33, the at least one control circuit can derive a first structured light depth map of an object by comparing a first frame of pixel data which is obtained by the sensor 24 to a pattern of the structured light which is emitted by the illuminator 26, and derive a second structured light depth map of the object by comparing a second frame of pixel data which is obtained by the sensor 29 to the pattern of the structured light. The at least one control circuit can use the software 35 to derive a merged depth map which is based on the first and second structured light depth maps. A structured light depth map is discussed further below, e.g., in connection with FIG. 5A.

Also, the at least one control circuit can use the software 34 to derive at least a first stereoscopic depth map of the object by stereoscopic matching of a first frame of pixel data obtained by the sensor 24 to a second frame of pixel data obtained by the sensor 29, and to derive at least a second stereoscopic depth map of the object by stereoscopic matching of the second frame of pixel data to the first frame of pixel data. The software 25 can merge one or more structured light depth maps and/or stereoscopic depth maps. A stereoscopic depth map is discussed further below, e.g., in connection with FIG. 5B.

The at least one control circuit can be provided by a processor which is outside the depth camera system as well, such as the processor 192 or any other processor. The at least one control circuit can access software from the memory 31, for instance, which can be a tangible computer readable storage having computer readable software embodied thereon for programming at least one processor or controller 32 to perform a method for processing image data in a depth camera system as described herein.

The memory 31 can store instructions that are executed by the processor 32, as well as storing images such as frames of pixel data 36, captured by the sensors or color camera. For example, the memory 31 may include random access memory (RAM), read only memory (ROM), cache, flash memory, a hard disk, or any other suitable tangible computer readable storage component. The memory component 31 may be a separate component in communication with the image capture component 22 and the processor 32 via a bus 21. According to another embodiment, the memory component 31 May be integrated into the processor 32 and/or the image capture component 22.

The depth camera system 20 may be in communication with the computing environment 12 via a communication link 37, such as a wired and/or a wireless connection. The computing environment 12 may provide a clock signal to the depth camera system 20 via the communication link 37 that indicates when to capture image data from the physical space which is in the field of view of the depth camera system 20.

Additionally, the depth camera system 20 may provide the depth information and images captured by, for example, the image sensors 24 and 29 and/or the color camera 28, and/or a skeletal model that may be generated by the depth camera system 20 to the computing environment 12 via the communication link 37. The computing environment 12 may then use the model, depth information and captured images to control an application. For example, as shown in FIG. 2, the computing environment 12 may include a gestures library 190, such as a collection of gesture filters, each having information concerning a gesture that may be performed by the skeletal model (as the user moves). For example, a gesture filter can be provided for various hand gestures, such as swiping or flinging of the hands. By comparing a detected motion to each filter, a specified gesture or movement which is performed by a person can be identified. An extent to which the movement is performed can also be determined.

The data captured by the depth camera system 20 in the form of the skeletal model and movements associated with it may be compared to the gesture filters in the gesture library 190 to identify when a user (as represented by the skeletal model) has performed one or more specific movements. Those movements may be associated with various controls of an application.

The computing environment may also include a processor 192 for executing instructions which are stored in a memory 194 to provide audio-video output signals to the display device 196 and to achieve other functionality as described herein.

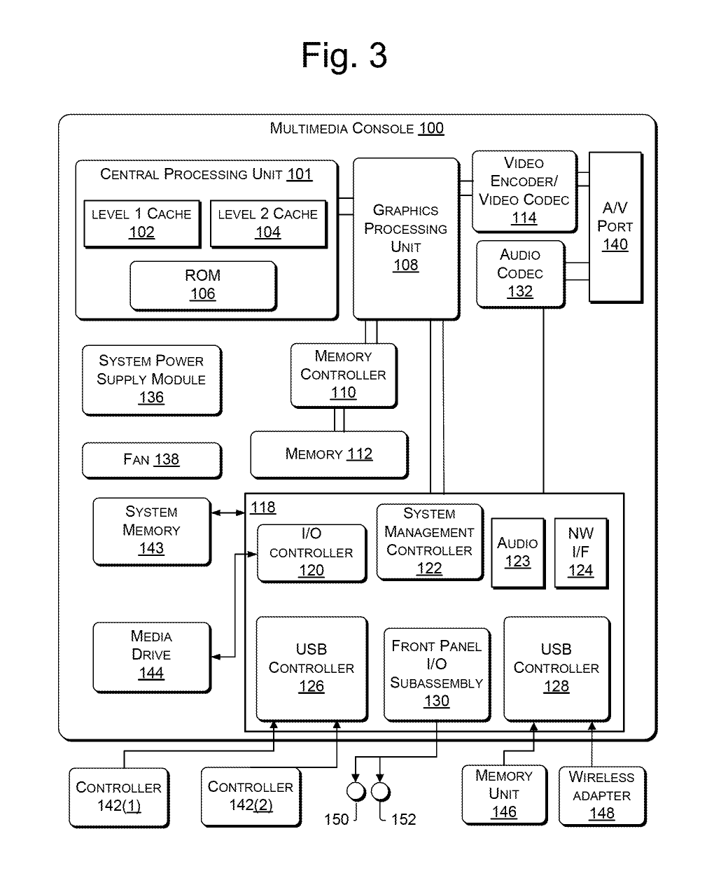

FIG. 3 depicts an example block diagram of a computing environment that may be used in the motion capture system of FIG. 1. The computing environment can be used to interpret one or more gestures or other movements and, in response, update a visual space on a display. The computing environment such as the computing environment 12 described above may include a multimedia console 100, such as a gaming console. The multimedia console 100 has a central processing unit (CPU) 101 having a level 1 cache 102, a level 2 cache 104, and a flash ROM (Read Only Memory) 106. The level 1 cache 102 and a level 2 cache 104 temporarily store data and hence reduce the number of memory access cycles, thereby improving processing speed and throughput. The CPU 101 may be provided having more than one core, and thus, additional level 1 and level 2 caches 102 and 104. The memory 106 such as flash ROM may store executable code that is loaded during an initial phase of a boot process when the multimedia console 100 is powered on.

A graphics processing unit (GPU) 108 and a video encoder/video codec (coder/decoder) 114 form a video processing pipeline for high speed and high resolution graphics processing. Data is carried from the graphics processing unit 108 to the video encoder/video codec 114 via a bus. The video processing pipeline outputs data to an A/V (audio/video) port 140 for transmission to a television or other display. A memory controller 110 is connected to the GPU 108 to facilitate processor access to various types of memory 112, such as RAM (Random Access Memory).

The multimedia console 100 includes an I/O controller 120, a system management controller 122, an audio processing unit 123, a network interface 124, a first USB host controller 126, a second USB controller 128 and a front panel I/O subassembly 130 that are preferably implemented on a module 118. The USB controllers 126 and 128 serve as hosts for peripheral controllers 142(1)-142(2), a wireless adapter 148, and an external memory device 146 (e.g., flash memory, external CD/DVD ROM drive, removable media, etc.). The network interface (NW IF) 124 and/or wireless adapter 148 provide access to a network (e.g., the Internet, home network, etc.) and may be any of a wide variety of various wired or wireless adapter components including an Ethernet card, a modem, a Bluetooth module, a cable modern, and the like.

System memory 143 is provided to store application data that is loaded during the boot process. A media drive 144 is provided and may comprise a DVD/CD drive, hard drive, or other removable media drive. The media drive 144 may be internal or external to the multimedia console 100. Application data may be accessed via the media drive 144 for execution, playback, etc. by the multimedia console 100. The media drive 144 is connected to the I/O controller 120 via a bus, such as a Serial ATA bus or other high speed connection.

The system management controller 122 provides a variety of service functions related to assuring availability of the multimedia console 100. The audio processing unit 123 and an audio codec 132 form a corresponding audio processing pipeline with high fidelity and stereo processing. Audio data is carried between the audio processing unit 123 and the audio codec 132 via a communication link. The audio processing pipeline outputs data to the A/V port 140 for reproduction by an external audio player or device having audio capabilities.

The front panel I/O subassembly 130 supports the functionality of the power button 150 and the eject button 152, as well as any LEDs (light emitting diodes) or other indicators exposed on the outer surface of the multimedia console 100. A system power supply module 136 provides power to the components of the multimedia console 100. A fan 138 cools the circuitry within the multimedia console 100.

The CPU 101, GPU 108, memory controller 110, and various other components within the multimedia console 100 are interconnected via one or more buses, including serial and parallel buses, a memory bus, a peripheral bus, and a processor or local bus using any of a variety of bus architectures.

When the multimedia console 100 is powered on, application data may be loaded from the system memory 143 into memory 112 and/or caches 102, 104 and executed on the CPU 101. The application may present a graphical user interface that provides a consistent user experience when navigating to different media types available on the multimedia console 100. In operation, applications and/or other media contained within the media drive 144 may be launched or played from the media drive 144 to provide additional functionalities to the multimedia console 100.

The multimedia console 100 may be operated as a standalone system by simply connecting the system to a television or other display. In this standalone mode, the multimedia console 100 allows one or more users to interact with the system, watch movies, or listen to music. However, with the integration of broadband connectivity made available through the network interface 124 or the wireless adapter 148, the multimedia console 100 may further be operated as a participant in a larger network community.

When the multimedia console 100 is powered on, a specified amount of hardware resources are reserved for system use by the multimedia console operating system. These resources may include a reservation of memory (e.g., 16 MB), CPU and GPU cycles (e.g., 5%), networking bandwidth (e.g., 8 kbs), etc. Because these resources are reserved at system boot time, the reserved resources do not exist from the application's view.

In particular, the memory reservation preferably is large enough to contain the launch kernel, concurrent system applications and drivers. The CPU reservation is preferably constant such that if the reserved CPU usage is not used by the system applications, an idle thread will consume any unused cycles.

With regard to the GPU reservation, lightweight messages generated by the system applications (e.g., popups) are displayed by using a GPU interrupt to schedule code to render popup into an overlay. The amount of memory required for an overlay depends on the overlay area size and the overlay preferably scales with screen resolution. Where a full user interface is used by the concurrent system application, it is preferable to use a resolution independent of application resolution. A scaler may be used to set this resolution such that the need to change frequency and cause a TV resynch is eliminated.

After the multimedia console 100 boots and system resources are reserved, concurrent system applications execute to provide system functionalities. The system functionalities are encapsulated in a set of system applications that execute within the reserved system resources described above. The operating system kernel identifies threads that are system application threads versus gaming application threads. The system applications are preferably scheduled to run on the CPU 101 at predetermined times and intervals in order to provide a consistent system resource view to the application. The scheduling is to minimize cache disruption for the gaming application running on the console.

When a concurrent system application requires audio, audio processing is scheduled asynchronously to the gaming application due to time sensitivity. A multimedia console application manager (described below) controls the gaming application audio level (e.g., mute, attenuate) when system applications are active.

Input devices (e.g., controllers 142(1) and 142(2)) are shared by gaming applications and system applications. The input devices are not reserved resources, but are to be switched between system applications and the gaming application such that each will have a focus of the device. The application manager preferably controls the switching of input stream, without knowledge the gaming application's knowledge and a driver maintains state information regarding focus switches. The console 100 may receive additional inputs from the depth camera system 20 of FIG. 2, including the sensors 24 and 29.

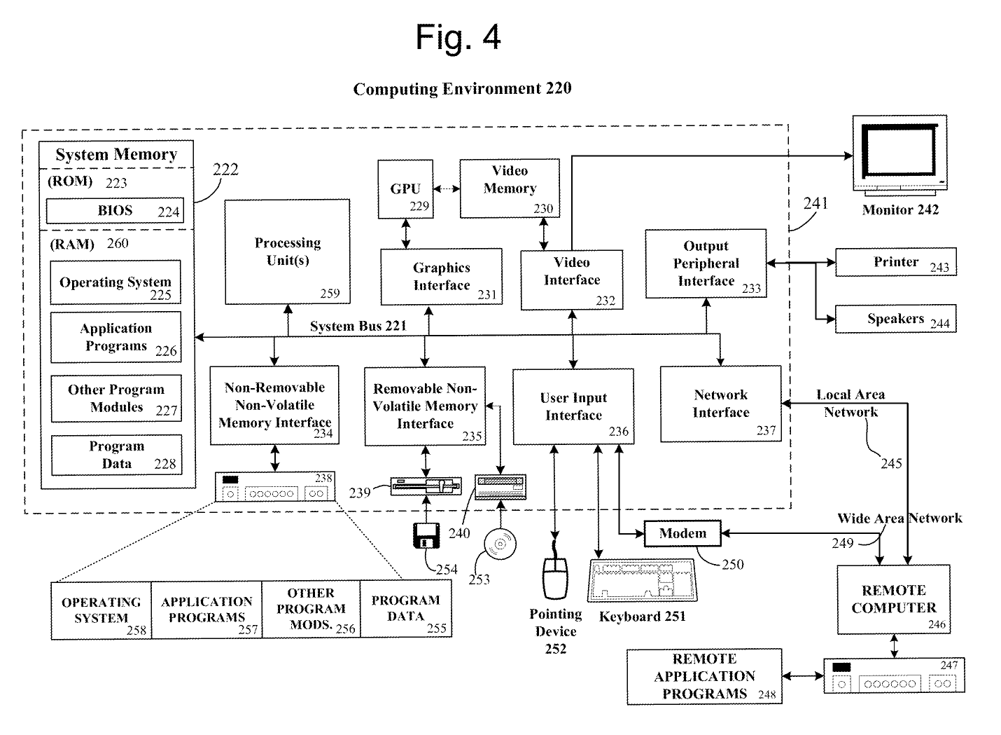

FIG. 4 depicts another example block diagram of a computing environment that may be used in the motion capture system of FIG. 1. In a motion capture system, the computing environment can be used to interpret one or more gestures or other movements and, in response, update a visual space on a display. The computing environment 220 comprises a computer 241, which typically includes a variety of tangible computer readable storage media. This can be any available media that can be accessed by computer 241 and includes both volatile and nonvolatile media, removable and non-removable media. The system memory 222 includes computer storage media in the form of volatile and/or nonvolatile memory such as read only memory (ROM) 223 and random access memory (RAM) 260. A basic input/output system 224 (BIOS), containing the basic routines that help to transfer information between elements within computer 241, such as during start-up, is typically stored in ROM 223. RAM 260 typically contains data and/or program modules that are immediately accessible to and/or presently being operated on by processing unit 259. A graphics interface 231 communicates with a GPU 229. By way of example, and not limitation, FIG. 4 depicts operating system 225, application programs 226, other program modules 227, and program data 228.

The computer 241 may also include other removable/non-removable, volatile/nonvolatile computer storage media, e.g., a hard disk drive 238 that reads from or writes to non-removable, nonvolatile magnetic media, a magnetic disk drive 239 that reads from or writes to a removable, nonvolatile Magnetic disk 254, and an optical disk drive 240 that reads from or writes to a removable, nonvolatile Optical disk 253 such as a CD ROM or other optical media. Other removable/non-removable, volatile/nonvolatile tangible computer readable storage media that can be used in the exemplary operating environment include, but are not limited to, magnetic tape cassettes, flash memory cards, digital versatile disks, digital video tape, solid state RAM, solid state ROM, and the like. The hard disk drive 238 is typically connected to the system bus 221 through an-non-removable memory interface such as interface 234, and magnetic disk drive 239 and optical disk drive 240 are typically connected to the system bus 221 by a removable memory interface, such as interface 235.

The drives and their associated computer storage media discussed above and depicted in FIG. 4, provide storage of computer readable instructions, data structures, program modules and other data for the computer 241. For example, hard disk drive 238 is depicted as storing operating system 258, application programs 257, other program modules 256, and program data 255. Note that these components can either be the same as or different from operating system 225, application programs 226, other program modules 227, and program data 228. Operating system 258, application programs 257, other program modules 256, and program data 255 are given different numbers here to depict that, at a minimum, they are different copies. A user may enter commands and information into the computer 241 through input devices such as a keyboard 251 and pointing device 252, commonly referred to as a mouse, trackball or touch pad. Other input devices (not shown) may include a microphone, joystick, game pad, satellite dish, scanner, or the like. These and other input devices are often connected to the processing unit 259 through a user input interface 236 that is coupled to the system bus, but may be connected by other interface and bus structures, such as a parallel port, game port or a universal serial bus (USB). The-depth camera system 20 of FIG. 2, including sensors 24 and 29, may define additional input devices for the console 100. A monitor 242 or other type of display is also connected to the system bus 221 via an interface, such as a video interface 232. In addition to the monitor, computers may also include other peripheral output devices such as speakers 244 and printer 243, which may be connected through a output peripheral interface 233.

The computer 241 may operate in a networked environment using logical connections to one or more remote computers, such as a remote computer 246. The remote computer 246 may be a personal computer, a server, a router, a network PC, a peer device or other common network node, and typically includes many or all of the elements described above relative to the computer 241, although only a memory storage device 247 has been depicted in FIG. 4. The logical connections include a local area network (LAN) 245 and a wide area network (WAN) 249, but may also include other networks. Such networking environments are commonplace in offices, enterprise-wide computer networks, intranets and the Internet.

When used in a LAN networking environment, the computer 241 is connected to the LAN 245 through a network interface or adapter 237. When used in a WAN networking environment, the computer 241 typically includes a modem 250 or other means for establishing communications over the WAN 249, such as the Internet. The modem 250, which may be internal or external, may be connected to the system bus 221 via the user input interface 236, or other appropriate mechanism. In a networked environment, program modules depicted relative to the computer 241, or portions thereof, may be stored in the remote memory storage device. By way of example, and not limitation, FIG. 4 depicts remote application programs 248 as residing on memory device 247. It will be appreciated that the network connections shown are exemplary and other means of establishing a communications link between the computers may be used.

The computing environment can include tangible computer readable storage having computer readable software embodied thereon for programming at least one processor to perform a method for processing image data in a depth camera system as described herein. The tangible computer readable storage can include, e.g., one or more of components 31, 194, 222, 234, 235, 230, 253 and 254. A processor can include, e.g., one or more of components 32, 192, 229 and 259.

FIG. 5A depicts an illumination frame and a captured frame in a structured light system. An illumination frame 500 represents an image plane of the illuminator, which emits structured light onto an object 520 in a field of view of the illuminator. The illumination frame 500 includes an axis system with x₂, y₂ and z₂ orthogonal axes. F₂ is a focal point of the illuminator and O₂ is an origin of the axis system, such as at a center of the illumination frame 500. The emitted structured light can include stripes, spots or other known illumination pattern. Similarly, a captured frame 510 represents an image plane of a sensor, such as sensor 24 or 29 discussed in connection with FIG. 2. The captured frame 516 includes an axis system with x₁, y₁ and z₁ orthogonal axes. F₁ is a focal point of the sensor and O₁ is an origin of the axis system, such as at a center of the captured frame 510. In this example, y₁ and y₂ are aligned collinearly and z₁ and z₂ are parallel, for simplicity, although this is not required. Also, two or more sensors can be used but only one sensor is depicted here, for simplicity.

Rays of projected structured light are emitted from different x₂, y₂ locations in the illuminator plane, such as an example ray 502 which is emitted from a point P₂ on the illumination frame 500. The ray 502 strikes the object 520, e.g., a person, at a point P₀ and is reflected in many directions. A ray 512 is an example reflected ray which travels from P₀ to a point P₁ on the captured frame 510. P₁ is represented by a pixel in the sensor so that its x₁, y₁ location is known. By geometric principles, P₂ lies on a plane which includes P₁, F₁ and F₂. A portion of this plane which intersects the illumination frame 500 is the epi-polar line 505. By identifying which portion of the structured light is projected by P₂, the location of P₂ along the epi-polar line 505 can be identified. P₂ is a corresponding point of P₁. The closer the depth of the object, the longer the length of the epi-polar line.

Subsequently, the depth of P₀ along the z₁ axis can be determined by triangulation. This is a depth value which is assigned to the pixel P₁ in a depth map. For some points in the illumination frame 500, there may not be a corresponding pixel in the captured frame 510, such as due to an occlusion or due to the limited field of view of the sensor. For each pixel in the captured frame 510 for which a corresponding point is identified in the illumination frame 500, a depth value can be obtained. The set of depth values for the captured frame 510 provides a depth map of the captured frame 510. A similar process can be carried out for additional sensors and their respective captured frames. Moreover, when successive frames of video data are obtained, the process can be carried out for each frame.

FIG. 5B depicts two captured frames in a stereoscopic light system. Stereoscopic processing is similar to the processing described in FIG. 5A in that corresponding points in two frames are identified. However, in this case, corresponding pixels in two captured frames are identified, and the illumination is provided separately. An illuminator 550 provides projected light on the object 520 in the field of view of the illuminator. This light is reflected by the object and sensed by two sensors, for example. A first sensor obtains a frame 530 of pixel data, while a second sensor obtains a frame 540 of pixel data. An example ray 532 extends from a point P₀ on the object to a pixel P₂ in the frame 530, passing through a focal point F₂ of the associated sensor. Similarly, an example ray 542 extends from a point P₀ on the object to a pixel P₁ in the frame 540, passing through a focal point F₁ of the associated sensor. From the perspective of the frame 540, stereo Matching can involve identifying the point P₂ On the epi polar line 545 which corresponds to P₁. Similarly, from the perspective of the frame 530, stereo matching can involve identifying the point P₁ on the epi-polar line 548 which corresponds to P₂. Thus, stereo matching can be performed separately, once for each frame of a pair of frames. In some cases, stereo matching in one direction, from a first frame to a second frame, can be performed without performing stereo matching in the other direction, from the second frame to the first frame.

The depth of P₀ along the z₁ axis can be determined by triangulation. This is a depth value which is assigned to the pixel P₁ in a depth map. For some points in the frame 540, there may not be a corresponding pixel in the frame 530, such as due to an occlusion or due to the limited field of view of the sensor. For each pixel in the frame 540 for which a corresponding pixel is identified in the frame 530, a depth value can be obtained. The set of depth values for the frame 540 provides a depth map of the frame 540.

Similarly, the depth of P₂ along the z₂ axis can be determined by triangulation. This is a depth value which is assigned to the pixel P₂ in a depth map. For some points in the frame 530, there may not be a corresponding pixel in the frame 540, such as due to an occlusion or due to the limited field of view of the sensor. For each pixel in the frame 530 for which a corresponding pixel is identified in the frame 540, a depth value can be obtained. The set of depth values for the frame 530 provides a depth map of the frame 530.

A similar process can be carried out for additional sensors and their respective captured frames. Moreover, when successive frames of video data are obtained, the process can be carried out for each frame.

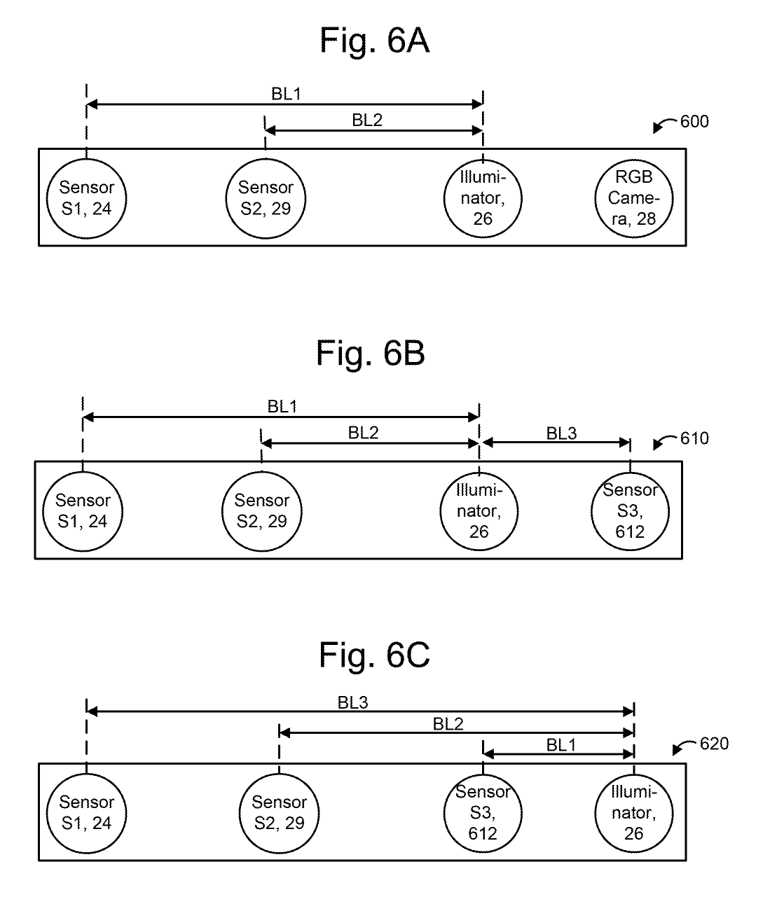

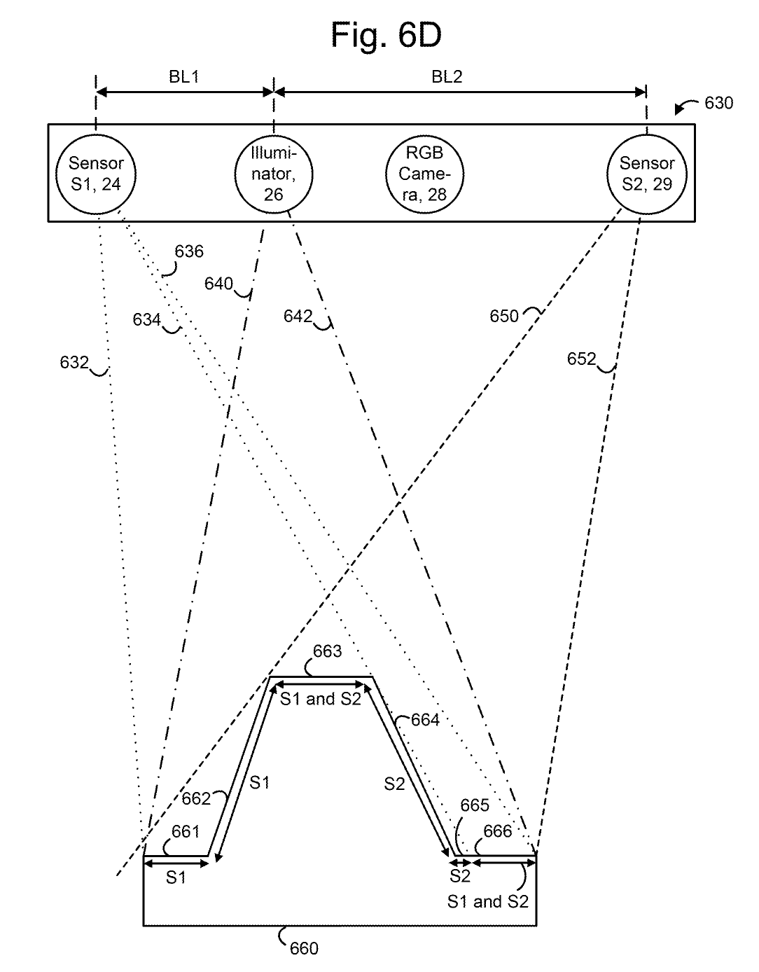

FIG. 6A depicts ah imaging component 600 having two sensors on a common side of an illuminator. The illuminator 26 is a projector which illuminates a human target or other object in a field of view with a structured light pattern The light source can be an infrared laser, for instance, having a wavelength of 700 nm-3,000 nm, including near-infrared light, having a Wavelength of 0.75 μm-1.4 μm, mid-wavelength infrared light having a wavelength of 3 μm- 8 μm, and long-wavelength infrared light having a wavelength of 8 μm-15 μm, which is a thermal imaging region which is closest to the infrared radiation emitted by humans. The illuminator can include a diffractive optical element (DOE) which receives the laser light and outputs multiple diffracted light beams. Generally, a DOE is used to provide multiple smaller light beams, such as thousands of smaller light beams, from a single collimated light beam. Each smaller light beam has a small fraction of the power of the single collimated light beam and the smaller, diffracted light beams may have a nominally equal intensity.

The smaller light beams define a field of view of the illuminator in a desired predetermined pattern. The DOE is a beam replicator, so all the output beams will have the same geometry as the input beam. For example, in a motion tracking system, it may be desired to illuminate a room in a way which allows tracking of a human target who is standing or sitting in the room. To track the entire human target, the field of view should extend in a sufficiently wide angle, in height and width, to illuminate the entire height and width of the human and an area in which the human may move around when interacting with an application of a motion tracking system. An appropriate field of view can be set based on factors such as the expected height and width of the human, including the arm span when the arms are raised overhead or out to the sides, the size of the area over which the human may move when interacting with the application, the expected distance of the human from the camera and the focal length of the camera.

An RGB camera 28, discussed previously, may also be provided. An RGB camera may also be provided in FIGS. 6B and 6C but is not depicted for simplicity.

In this example, the sensors 24 and 29 are on a common side of the illuminator 26. The sensor 24 is at a baseline distance BL1 from the illuminator 26, and the sensor 29 is at a baseline distance BL2 from the illuminator 26. The sensor 29 is optimized for shorter range imaging by virtue of its smaller baseline, while the sensor 24 is optimized for longer range imaging by virtue of its longer baseline. Moreover, by placing both sensors on one side of the illuminator, a longer baseline can be achieved for the sensor which is furthest from the illuminator, for a fixed size of the imaging component 600 which typically includes a housing which is limited in size. On the other hand, a shorter baseline improves shorter range imaging because the sensor can focus on closer objects, assuming a given focal length, thereby allowing a more accurate depth measurement for shorter distances. A shorter baseline results in a smaller disparity and minimum occlusions.

A longer baseline improves the accuracy of longer range imaging because there is a larger angle between the light rays of corresponding points, which means that image pixels can detect smaller differences in the distance. For example, in FIG. 5A it can be seen that an angle between rays 502 and 512 will be greater if the frames 500 and 510 are further apart. And, in FIG. 5B it can be seen that an angle between rays 532 and 542 will be, greater if the frames 530 and 540 are further apart. The process of triangulation to determine depth is more accurate when the sensors are further apart so that the angle between the light rays is greater.

In addition to setting an optimal baseline for a sensor according to whether shorter or longer range imaging is being optimized, within the constraints of the housing of the imaging component 600, other characteristics of a sensor can be set to optimize shorter or longer range imaging. For example, a spatial resolution of a camera can be optimized. The spatial resolution of a sensor such as a charge-coupled device (CCD) is a function of the number of pixels and their size relative to the projected image, and is a measure of how fine a detail can be detected by the sensor. For a sensor which is optimized for shorter range imaging, a lower spatial resolution can be acceptable, compared to a sensor which is optimized for longer range imaging. A lower spatial resolution can be achieved by using relatively fewer pixels in a frame, and/or relatively larger pixels, because the pixel size relative to the project image is relatively greater due to the shorter depth of the detected object in the field of view. This can result in cost savings and reduced energy consumption. On the other hand, for a sensor which is optimized for longer range imaging, a higher spatial resolution should be used, compared to a sensor which is optimized for shorter range imaging. A higher spatial resolution Can be achieved by using relatively more pixels in a frame, and/or relatively smaller pixels, because the pixel size relative to the project image is relatively smaller due to the longer depth of the detected object in the field of view. A higher resolution produces a higher accuracy in the depth measurement.

Another characteristic of a sensor that can be set to optimize shorter or longer range imaging is sensitivity. Sensitivity refers to the extent to which a sensor reacts to incident light. One measure of sensitivity is quantum efficiency, which is the percentage of photons incident upon a photoreactive surface of the sensor, such as a pixel, that will produce an electron—hole pair. For a sensor optimized for shorter range imaging, a lower sensitivity is acceptable because relatively more photons will be incident upon each pixel due to the closer distance of the object which reflects the photons back to the sensor. A lower sensitivity can be achieved, e.g., by a lower quality sensor, resulting in cost savings. On the other hand, for a sensor which is optimized for longer range imaging, a higher sensitivity should be used, compared to a sensor which is optimized for shorter range imaging. A higher sensitivity can be achieved by using a higher quality sensor, to allow detection where relatively fewer photons will be incident upon each pixel due to the further distance of the object which reflects the photons back to the sensor.

Another characteristic of a sensor that can be set to optimize shorter or longer range imaging is exposure time. Exposure time is the amount of time in which light is allowed to fall on the pixels of the sensor during the process of obtaining a frame of image data, e.g., the time in which a camera shutter is open. During the exposure time, the pixels of the sensor accumulate or integrate charge. Exposure time is related to sensitivity, in that a longer exposure time can compensate for a lower sensitivity. However, a shorter exposure time is desirable to accurately capture motion sequences at shorter range, since a given movement of the imaged object translates to larger pixel offsets when the object is closer. A shorter exposure time can be used for a sensor which is optimized for shorter range imaging, while a longer exposure time can be used for a sensor which is optimized for longer range imaging. By using an appropriate exposure time, over exposure/image saturation of a closer object and under exposure of a further object, can be avoided.

FIG. 6B depicts an imaging component 610 having two sensors on one side of an illuminator, and one sensor on an opposite side of the illuminator. Adding a third sensor in this manner can result in imaging of an object with fewer occlusions, as well as more accurate imaging due to the additional depth measurements which are obtained. One sensor such as sensor 612 can be positioned close to the illuminator, while the other two sensors are on opposite sides of the illuminator. In this example, the sensor 24 is at a baseline distance BL1 from the illuminator 26, the sensor 29 is at a baseline distance BL2 from the illuminator 26, and the third sensor 612 is at a baseline distance 130 from the illuminator 26.

FIG. 6C depicts an imaging component 620 having three sensors on a common side of an illuminator. Adding a third sensor in this manner can result in more accurate imaging due to the additional depth measurements which are obtained. Moreover, each sensor can be optimized for a different depth range. For example, sensor 24, at the larger baseline distance BL3 from the illuminator, can be optimized for longer range imaging. Sensor 29, at the intermediate baseline distance BL2 from the illuminator, can be optimized for medium range imaging. And, sensor 612, at the smaller baseline distance BL1 from the illuminator, can be optimized for shorter range imaging. Similarly, spatial resolution, sensitivity and/or exposure times can be optimized to longer range levels for the sensor 24, intermediate range levels for the sensor 29, and shorter range levels for the sensor 612.

FIG. 6D depicts an imaging component 630 having two sensors on opposing sides of an illuminator, showing how the two sensors sense different portions of an object. A sensor S1 24 is at a baseline distance BL1 from the illuminator 26 and is optimized for shorter range imaging. A sensor S2 29 is at a baseline distance BL2>BL1 from the illuminator 26 and is optimized for longer range imaging. An RGB camera 28 is also depicted. An object 660 is present in a field of view. Note that the perspective of the drawing is modified as a simplification, as the imaging component 630 is shown from a front view and the object 660 is shown from a top view. Rays 640 and 642 are example rays of light which are projected by the illuminator 26. Rays 632, 634 and 636 are example rays of reflected light which are sensed by the sensor S1 24, and rays 650 and 652 are example rays of reflected light which are sensed by the sensor S2 29.

The object includes five surfaces which are sensed by the sensors S1 24 and S2 29. However, due to occlusions, not all surfaces are sensed by both sensors. For example, a surface 661 is sensed by sensor S1 24 only and is occluded from the perspective of sensor S2 29. A surface 662 is also sensed by sensor S1 24 only and is occluded from the perspective of sensor S2 29. A surface 663 is sensed by both sensors S1 and S2. A surface 664 is sensed by sensor S2 only rind is occluded from the perspective of sensor S1. A surface 665 is sensed by sensor S2 only and is occluded from the perspective of sensor S1. A surface 666 is sensed by both sensors S1 and S2. This indicates how the addition of a second sensor, or other additional sensors, can be used to image portions of an object which would otherwise be occluded. Furthermore, placing the sensors as far as a practical from the illuminator is often desirable to minimize occlusions.

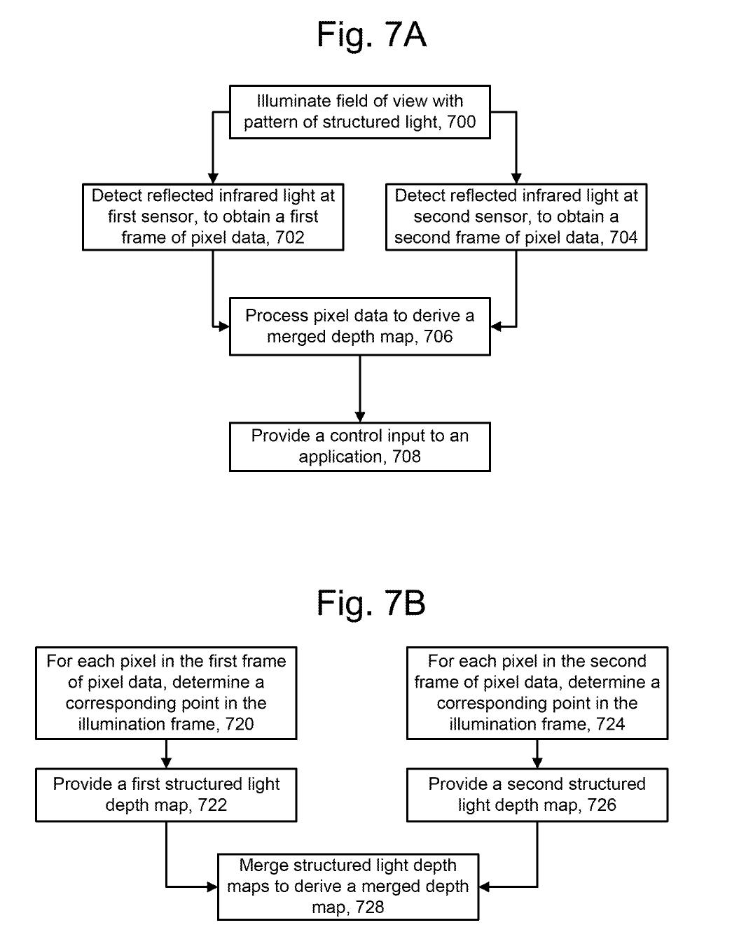

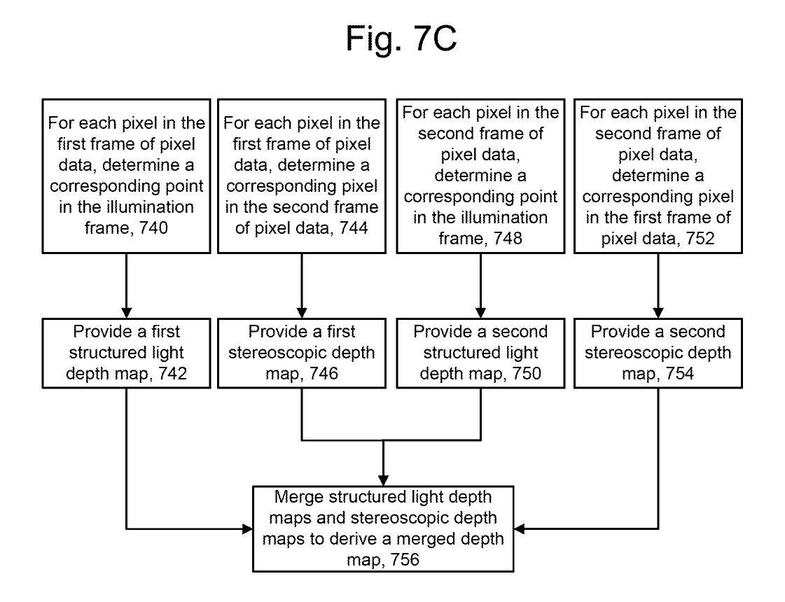

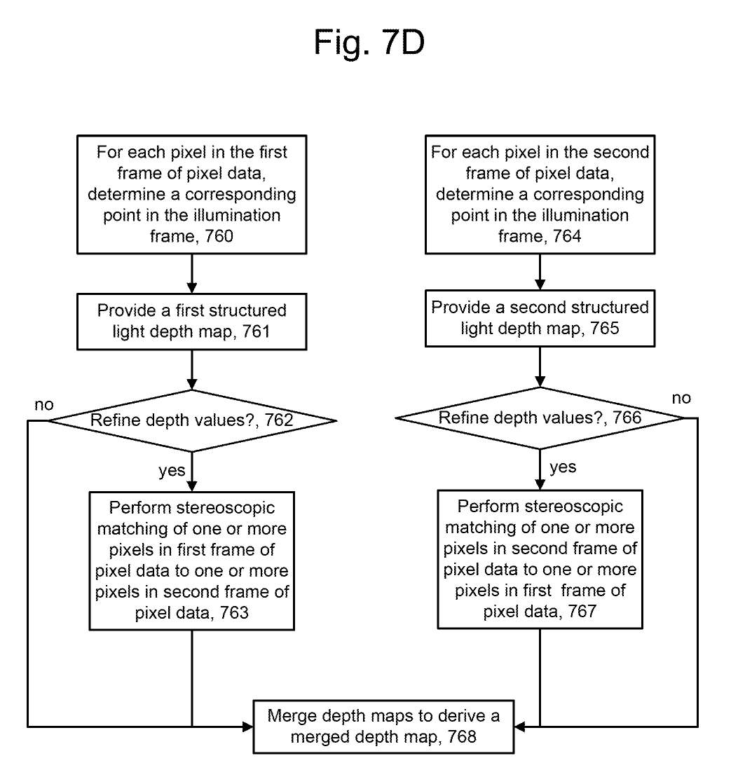

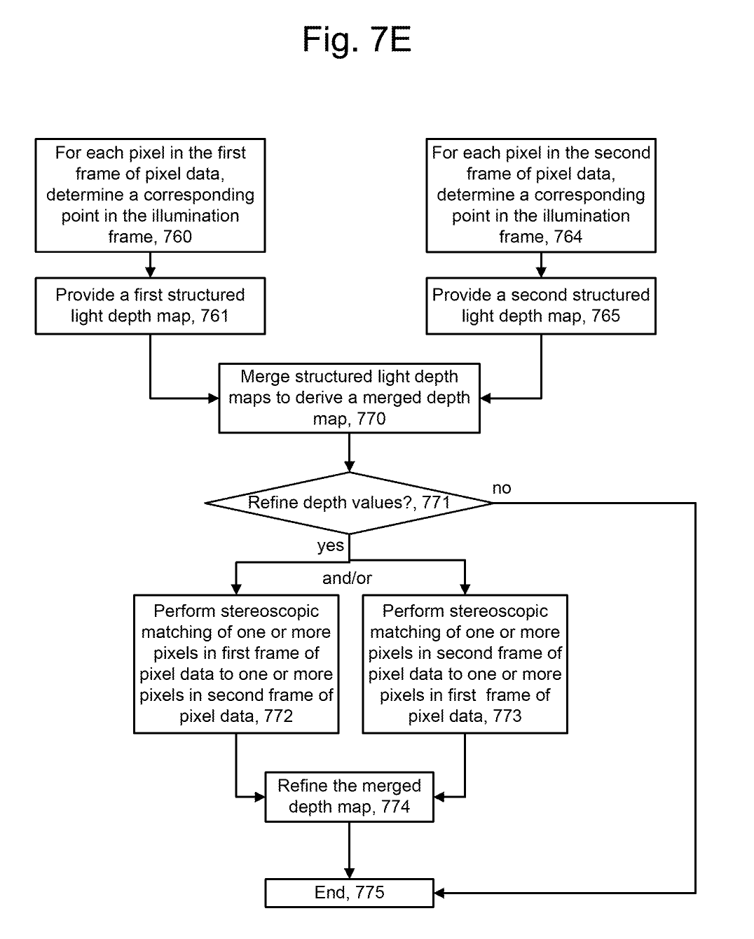

FIG. 7A depicts a process for obtaining a depth map of a field of view. Step 700 includes illuminating a field of view with a pattern of structured light. Any type of structured light can be used, including coded structured light. Steps 702 and 704 can be performed concurrently at least in part. Step 702 includes detecting reflected infrared light at a first sensor, to obtain a first frame of pixel data. This pixel data can indicate, e.g., an amount of charge which was accumulated by each pixel during an exposure time, as an indication of an amount of light which was incident upon the pixel from the field of view. Similarly, step 704 includes detecting reflected infrared light at a second sensor, to obtain a second frame of pixel data. Step 706 includes processing the pixel data from both frames to derive a merged depth map. This can involve different techniques such as discussed further in connection with FIGS. 7B-7E. Step 708 includes providing a control input to an application based on the merged depth map. This control input can be used for various purposes such as updating the position of an avatar on a display, selecting a menu item in a user interface (UI), or many other possible actions.

FIG. 7B depicts further details of step 706 of FIG. 7A, in which two structured light depth maps are merged. In this approach, first and second structured light depth maps are obtained from the first and second frames, respectively, and the two depth maps are merged. The process can be extended to merge any number of two or more depth maps. Specifically, at step 720, for each pixel in the first frame of pixel data (obtained in step 702 of FIG. 7A), an attempt is made to determine a corresponding point in the illumination frame, by matching the pattern of structured light. In some case, due to occlusions or other factors, a corresponding point in the illumination frame may not be successfully determined for one or more pixels in the first frame. At step 722, a first structured light depth map is provided. This depth map can identify each pixel in the first frame and a corresponding depth value. Similarly, at step 724, for each pixel in the second frame of pixel data (obtained in step 704 of FIG. 7A), an attempt is made to determine a corresponding point in the illumination frame. In some case, due to occlusions or other factors, a corresponding point in the illumination frame may not be successfully determine for one or more pixels in the second frame. At step 726, a second structured light depth map is provided. This depth map can identify each pixel in the second frame and a corresponding depth value. Steps 720 and 722 can be performed concurrently at least in part with steps 724 and 726. At step 728, the structured light depth maps are merged to derive the merged depth app of step 706 of FIG. 7A.

The merging can be based on different approaches, including approaches which involve unweighted averaging, weighted averaging, accuracy measures and/or confidence measures. in one approach, for each pixel, the depth values are averaged among the two or more depth maps. An example unweighted average of a depth value d1 for an ith pixel in the first frame and a depth value d2 for an ith pixel in the second frame is (d1+d2)/2. An example weighted average of a depth value d1 of weight w1 for an ith pixel in the first frame and a depth value d2 of weight w2 for an ith pixel in the second frame is (w1*d1+w2*d2)/[(w1+w2)]. One approach to merging depth values assigns a weight to the depth values of a frame based on the baseline distance between the sensor and the illuminator, so that a higher weight, indicating a higher confidence, is assigned when the baseline distance is greater, and a lower weight, indicating a lower confidence, is assigned when the baseline distance is less. This is done since a larger baseline distance yields a more accurate depth value. For example, in FIG. 6D, we can assign a weight of w1=BL1/(BL1+BL2) to a depth value from sensor S1 and a weight of w2=BL2/(BL1+BL2) to a depth value from sensor S2. To illustrate, if we assume BL=1 and BL=2 distance units, w1=⅓ and w2=⅔. The weights can be applied on a per-pixel or per-depth value basis.

The above example could be augmented with a depth value obtained from stereoscopic matching of an image from the sensor S1 to an image from the sensor S2 based on the distance BL1+BL2 in FIG. 6D. In this case, we can assign w1=BL1/(BL1+BL2+BL1+BL2) to a depth value from sensor S1, a weight of w2=BL2/(BL1+BL2+BL1+BL2) to a depth value from sensor S2, and a weight of w3=(BL1+BL2)/(BL1+BL2+BL1+BL2) to a depth value obtained from stereoscopic matching from S1 to S2. To illustrate, if we assume BL=1 and BL=2 distance units, w1=⅙, w2= 2/6 and w3= 3/6. In a further augmentation, a depth value is obtained from stereoscopic matching of an image from the sensor S2 to an image from the sensor S1 in FIG. 6D. In this case, we can assign w1=BL1/(BL1+BL2+BL1+BL2+BL1+BL2) to a depth value from sensor S1, a weight of w2=BL2/(BL1+BL2+BL1+BL2+BL1+BL2) to a depth value from sensor S2, a weight of w3=(BL1+BL2)/(BL1+BL2+BL1+BL2+BL1+BL2) to a depth value obtained from stereoscopic matching from S1 to S2, and a weight of w4=(BL1+BL2)/(BL1+BL2+BL1+BL2+BL1+BL2) to a depth value obtained from stereoscopic matching from S2 to S1. To illustrate, if we assume BL=1 and BL=2 distance units, w1= 1/9, w2= 2/9, w3= 3/9 and w4= 3/9. This is merely one possibility.

A weight can also be provided based on a confidence measure, such that a depth value with a higher confidence measure is assigned a higher weight. In one approach, an initial confidence measure is assigned to each pixel and the confidence measure is increased for each new frame in which the depth value is the same or close to the same, within a tolerance, based on the assumption that the depth of an object will not change quickly from frame to frame. For example, with a frame rate of 30 frames per second, a tracked human will not move significantly between frames. See U.S. Pat. No. 5,040,116, titled “Visual navigation and obstacle avoidance structured light system,” issued Aug. 13, 1991, incorporated herein by reference, for further details. In another approach, a confidence measure is a measure of noise in the depth value. For example, with the assumption that large changes in the depth value between neighboring pixels are unlikely to occur in reality, such large changes in the depth values can be indicative of a greater amount of noise, resulting in a lower confidence measure. See U.S. Pat. No. 6,751,338, titled “System and method of using range image data with machine vision tools,” issued Jun. 15, 2004, incorporated herein by reference, for further details. Other approaches for assigning confidence measure are also possible.

In one approach, a “master” camera coordinate system is defined, and we transform and resample the other depth image to the “master” coordinate system. Once we have the matching images, we can choose to take one or more samples into consideration where we may weight their confidence. An average is one solution, but not necessarily the best one as it doesn't solve cases of occlusions, where each camera might successfully observe a different location in space. A confidence measure can be associated with each depth value in the depth maps. Another approach is to merge the data in 3D space, where image pixels do not exist. In 3-D, volumetric methods can be utilized.

To determine whether a pixel has correctly matched a pattern and therefore has correct depth data, we typically perform correlation or normalized correlation between the image and the known projected pattern. This is done along epi-polar lines between the sensor and the illuminator. A successful match is indicated by a relatively strong local maximum of the correlation, which can be associated with a high confidence measure. On the other hand, a relatively weak local maximum of the correlation can be associated with a low confidence measure.

A weight can also be provided based on an accuracy measure, such that a depth value with a higher accuracy measure is assigned a higher weight. For example, based on the spatial resolution and the base line distances between the sensors and the illuminator, and between the sensors, we can assign an accuracy measure for each depth sample. Various techniques are known for determining accuracy measures. For example, see “Stereo Accuracy and Error Modeling,” by Point Grey Research, Richmond, BC, Canada, Apr. 19, 2004, http://www.ptgrey.com/support/kb/data/kbStereoAccuracyShort.pdf. We can then calculate a weighted-average, based on these accuracies. For example, for a measured 3D point, we assign the weight Wi=exp(−accuracy_i), where accuracy_i is an accuracy measure, and the averaged 3D point is Pavg=sum(Wi*Pi)/sum(Wi). Then, using these weights, point samples that are close in 3-D, might be merged using a weighted average.

To merge depth value data in 3D, we can project all depth images into 3D space using (X,Y,Z)=depth*ray+origin, where ray is a 3D vector from a pixel to the focal point of the sensor, and the origin is the location of the focal point of the sensor in 3D space. In 3D space, we calculate a normal direction for each depth data point. Further, for each data point, we look for a nearby data point from the other sources. in case the other data point is close enough and the dot product between the normal vectors of the points is positive, which means that they're oriented similarly and are not two sides of an object, then we merge the points into a single point. This merge can be performed, e.g., by calculating a weighted average of the 3D locations of the points. The weights can be defined by the confidence of the measurements, where confidence measures are the based on the correlation score.

FIG. 7C depicts further details of step 706 of FIG. 7A, in which two structured light depth maps and two stereoscopic depth maps are merged. In this approach, first and second structured light depth maps are obtained from the first and second frames, respectively. Additionally, one or more stereoscopic depth maps are obtained. The first and second structured light depth maps and the one or more stereoscopic depth maps are merged. The process can be extended to merge any number of two or more depth maps. Steps 740 and 742 can be performed concurrently at least in part with steps 744 and 746, steps 748 and 750, and steps 752 and 754. At step 740, for each pixel in the first frame of pixel data, we determine a corresponding point in the illumination frame and at step 742 we provide a first structured light depth map. At step 744, for each pixel in the first frame of pixel data, we determine a corresponding pixel in the second frame of pixel data and at step 746 we provide a first stereoscopic depth map. At step 748, for each pixel in a second frame of pixel data, we determine a corresponding point in the illumination frame and at step 750 we provide a second structured light depth map. At step 752, for each pixel in the second frame of pixel data, we determine a corresponding pixel in the first frame of pixel data and at step 754 we provide a second stereoscopic depth map. Step 756 includes merging the different depth maps.

The merging can be based on different approaches, including approaches which involve unweighted averaging, weighted averaging, accuracy measures and/or confidence measures.

In this approach, two stereoscopic depth maps are merged with two structured light depth maps. In one option, the merging considers all depth maps together in a single merging step. In another possible approach, the merging occurs in multiple steps. For example, the structured light depth maps can be merged to obtain a first merged depth map, the stereoscopic depth maps can be merged to obtain a second merged depth map, and the first and second merged depth maps are merged to Obtain a final merged depth map. In another option where the merging occurs in multiple steps, the first structured light depth map is merged with the first stereoscopic depth map to obtain a first merged depth map, the second structured light depth map is merged with the second stereoscopic depth map to obtain a second merged depth map, and the first and second merged depth maps are merged to obtain a final merged depth map. Other approaches are possible as well.

In another approach, only one stereoscopic depth map is merged with two structured light depth maps. The merging can occur in one or more steps. In a multi-step approach, the first structured light depth map is merged with the stereoscopic depth map to obtain a first merged depth map, and the second structured light depth map is merged with the stereoscopic depth map to obtain the final merged depth map. Or, the two structured light depth maps are merged to obtain a first merged depth map, and the first merged depth map is merged with the stereoscopic depth map to obtain the final merged depth map. Other approaches are possible.

FIG. 7D depicts further details of step 706 of FIG. 7A, in which depth values are refined as needed using stereoscopic matching. This approach is adaptive in that stereoscopic matching is used to refine one or more depth values in response to detecting a condition that indicates refinement is desirable. The stereoscopic matching can be performed for only a subset of the pixels in a frame. In one approach, refinement of the depth value of a pixel is desirable when the pixel cannot be matched to the structured light pattern, so that the depth value is null or a default value. A pixel may not be matched to the structured light pattern due to occlusions, shadowing, lighting conditions, surface textures, or other reasons. In this case, stereoscopic matching can provide a depth value where no depth value was previous obtained, or can provide a more accurate depth value, in some cases, due to the sensors being spaced apart by a larger baseline, compared to the baseline spacing between the sensors and the illuminator. See FIGS. 2, 6B and 6D, for instance.

In another approach, refinement of the depth value of a pixel is desirable when the depth value exceeds a threshold distance, indicating that the corresponding point on the object is relatively far from the sensor. In this case, stereoscopic matching can provide a more accurate depth value, in case the baseline between the sensors is larger than the baseline between each of the sensors and the illuminator.

The refinement can involve providing a depth value where none was provided before, or merging depth values, e.g., based on different approaches which involve unweighted averaging, weighted averaging, accuracy measures and/or confidence measures. Further, the refinement can be performed for the frames of each sensor separately, before the depth values are merged.

By performing stereoscopic matching only for pixels for which a condition is detected indicating that refinement is desirable, unnecessary processing is avoided. Stereoscopic matching is not performed for pixels for which a condition is not detected indicating that refinement is desirable. However, it is also possible to perform stereoscopic matching for an entire frame when a condition is detected indicating that refinement is desirable for one or more pixels of the frame. In one approach, stereoscopic matching for an entire frame is initiated when refinement is indicated for a minimum number of portions of pixels in a frame.

At step 760, for each pixel in the first frame of pixel data, we determine a corresponding point in the illumination frame and at step 761, we provide a corresponding first structured light depth map. Decision step 762 determines if a refinement of a depth value is indicated. A criterion can be evaluated for each pixel in the first frame of pixel data, arid, in one approach, can indicate whether refinement of the depth value associated with the pixel is desirable. In one approach, refinement is desirable when the associated depth value is unavailable or unreliable. Unreliability can be based on an accuracy measure and/or confidence measure, for instance. If the confidence measure exceeds a threshold confidence measure, the depth value may be deemed to be reliable. Or, if the accuracy measures exceeds a threshold accuracy measure, the depth value may be deemed to be reliable. In another approach, the confidence measure and the accuracy measure must both exceed respective threshold levels for the depth value to be deemed to be reliable.

In another approach, refinement is desirable when the associated depth value indicates that the depth is relatively distant, such as when the depth exceeds a threshold depth. If refinement is desired, step 763 performs stereoscopic matching of one or more pixels in the first frame of pixel data to one or more pixels in the second frame of pixel data. This results in one or more additional depth values of the first frame of pixel data.

Similarly, for the second frame of pixel data, at step 764, for each pixel in the second frame of pixel data, we determine a corresponding point in the illumination frame and at step 765, we provide a corresponding second structured light depth map. Decision step 766 determines if a refinement of a depth value is indicated. If refinement is desired, step 767 performs stereoscopic matching of one or more pixels in the second frame of pixel data to one or more pixels in the first frame of pixel data. This results in one or more additional depth values of the second frame of pixel data.

Step 768 merges the depth maps of the first and second frames of pixel data, where the merging include depth values obtained from the stereoscopic matching of steps 763 and/or 767. The merging can be based on different approaches, including approaches which involve unweighted averaging, weighted averaging, accuracy measures and/or confidence measures.

Note that, for a given pixel for which refinement was indicated, the merging can merge a depth value from the first structured light depth map, a depth value from the second structured light depth map; and one or more depth values from stereoscopic matching. This approach can provide a more reliable result compared to an approach which discards a depth value from structured light depth map and replaces it with a depth value from stereoscopic matching.

FIG. 7E depicts further details of another approach to step 706 of FIG. 7A, in which depth values of a merged depth map are refined as needed using stereoscopic matching. In this approach, the merging of the depth maps obtained by matching to a structured light pattern occurs before a refinement process. Steps 760, 761, 764 and 765 are the same as the like-numbered steps in FIG. 7D. Step 770 merges the structured light depth maps. The merging can be based on different approaches, including approaches which involve unweighted averaging, weighted averaging, accuracy measures and/or confidence measures. Step 771 is analogous to steps 762 and 766 of FIG. 7D and involves determining if refinement of a depth value is indicated.

A criterion can be evaluated for each pixel in the merged depth map, and, in one approach, can indicate whether refinement of the depth value associated with a pixel is desirable. In one approach, refinement is desirable when the associated depth value is unavailable or unreliable. Unreliability can be based on an accuracy measure and/or confidence measure, for instance. If the confidence measure exceeds a threshold confidence measure, the depth value may be deemed to be reliable. Or, if the accuracy measure exceeds a threshold accuracy measure, the depth value may be deemed to be reliable. In another approach, the confidence measure and the accuracy measure must both exceed respective threshold levels for the depth value to be deemed to be reliable. In another approach, refinement is desirable when the associated depth value indicates that the depth is relatively distant, such as when the depth exceeds a threshold depth. If refinement is desired, step 772 and/or step 773 can be performed. In some cases, it is sufficient to perform stereoscopic matching in one direction, by matching a pixel in one frame to a pixel in another frame. In other cases, stereoscopic matching in both directions can be performed. Step 772 performs stereoscopic matching of one or more pixels in the first frame of pixel data to one or more pixels in the second frame of pixel data. This results in one or more additional depth values of the first frame of pixel data. Step 773 performs stereoscopic matching of one or more pixels in the second frame of pixel data to one or more pixels in the first frame of pixel data. This results in one or more additional depth values of the second frame of pixel data.

Step 774 refines the merged depth map of step 770 for one or more selected pixels for which stereoscopic matching was performed. The refinement can involve merging depth value based on different approaches, including approaches which involve unweighted averaging, weighted averaging, accuracy measures and/or confidence measures.

If no refinement is desired at decision step 771, the process ends at step 775.

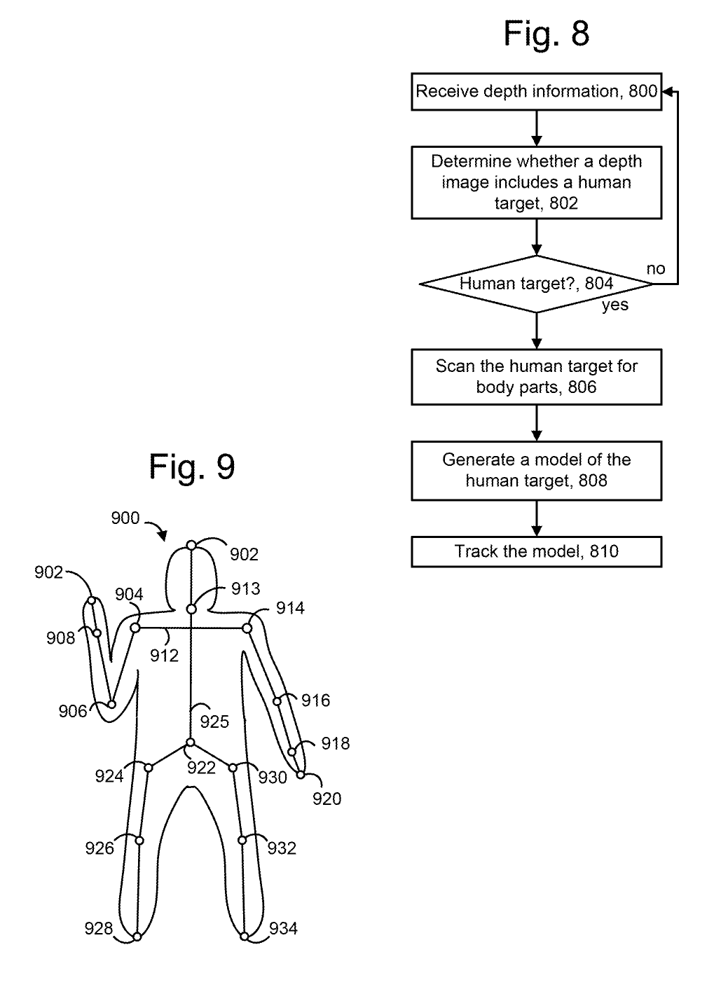

FIG. 8 depicts an example method for tracking a human target using a control input as set forth in step 708 of FIG. 7A. As mentioned, a depth camera system can be used to track movements of a user, such as a gesture. The movement can be processed as a control input at an application. For example, this could include updating the position of an avatar on a display, where the avatar represents the user, as depicted in FIG. 1, selecting a menu item in a user interface (UI), or many other possible actions.

The example method may be implemented using, for example, the depth camera system 20 and/or the computing environment 12, 100 or 420 as discussed in connection with FIGS. 2-4. One or more human targets can be scanned to generate a model such as a skeletal model, a mesh human model, or any other suitable representation of a person. In a skeletal model, each body part may be characterized as a mathematical vector defining joints and bones of the skeletal model. Body parts can move relative to one another at the joints.

The model may then be used to interact with an application that is executed by the computing environment. The scan to generate the model can occur when an application is started or launched, or at other times as controlled by the application of the scanned person.

The person may be scanned to generate a skeletal model that may be tracked such that physical movements motions of the user may act as a real-time user interface that adjusts and/or controls parameters of an application. For example, the tracked movements of a person may be used to move an avatar or other on-screen character in an electronic role-playing game, to control an on-screen vehicle in an electronic racing game, to control the building or organization of objects in a virtual environment, or to perform any other suitable control of an application.

According to one embodiment, at step 800, depth information is received, e.g., from the depth camera system. The depth camera system may capture or observe a field of view that may include one or more targets. The depth information may include a depth image or map having a plurality of observed pixels, where each observed pixel has an observed depth value, as discussed.

The depth image may be downsampled to a lower processing resolution so that it can be more easily used and processed with less computing overhead. Additionally, one or more high-variance and/or noisy depth values may be removed and/or smoothed from the depth image; portions of missing and/or removed depth information may be filled in and/or reconstructed; and/or any other suitable processing may be performed on the received depth information such that the depth information may used to generate a model such as a skeletal model (see FIG. 9).

Step 802 determines whether the depth image includes a human target. This can include flood filling each target or object in the depth image comparing each target or object to a pattern to determine whether the depth image includes a human target. For example, various depth values of pixels in a selected area or point of the depth image may be compared to determine edges that may define targets or objects as described above. The likely Z values of the Z layers may be flood filled based on the determined edges. For example, the pixels associated with the determined edges and the pixels of the area within the edges may be associated with each other to define a target or an object in the capture area that may be compared with a pattern, which will be described in more detail below.

If the depth image includes a human target, at decision step 804, step 806 is performed. If decision step 804 is false, additional depth information is received at step 800.

The pattern to which each target or object is compared may include one or more data structures having a set of variables that collectively define a typical body of a human. Information associated with the pixels of, for example, a human target and a non-human target in the field of view, may be compared with the variables to identify a human target. In one embodiment, each of the variables in the set may be weighted based on a body part. For example, various body parts such as a head and/or shoulders in the pattern may have weight value associated therewith that may be greater than other body parts such as a leg. According to one embodiment, the weight values may be used when comparing a target with the variables to determine whether and which of the targets may be human. For example, matches between the variables and the target that have larger weight values may yield a greater likelihood of the target being human than matches with smaller weight values.

Step 806 includes scanning the human target for body parts. The human target may be scanned to provide measurements such as length, width, or the like associated with one or more body parts of a person to provide an accurate model of the person. In an example embodiment, the human target may be isolated and a bitmask of the human target may be created to scan for one or more body parts. The bitmask may be created by, for example, flood filling the human tar_{g}et such that the human target may be separated from other targets or objects in the capture area elements. The bitmask may then be analyzed for one or more body parts to generate a model such as a Skeletal model, a mesh human model, Or the like of the human target. For example, according to one embodiment, measurement values determined by the scanned bitmask may be used to define one or more joints in a skeletal model. The one or more joints may be used to define one or more bones that may correspond to a body part of a human.

For example, the top of the bitmask of the human target may be associated with a location of the top of the head. After determining the top of the head, the bitmask may be scanned downward to then determine a location of a neck, a location of the shoulders and so forth. A width of the bitmask, for example, at a position being scanned, may be compared to a threshold value of a typical width associated with, for example, a neck, shoulders, or the like. In an alternative embodiment, the distance from a previous position scanned and associated with a body part in a bitmask may be used to determine the location of the neck, shoulders or the like. Some body parts such as legs, feet, or the like may be calculated based on, for example, the location of other body parts. Upon determining the values of a body part, a data structure is created that includes measurement values of the body part. The data structure may include scan results averaged from multiple depth images which are provide at different points in time by the depth camera system.

Step 808 includes generating a model of the human target. In one embodiment, measurement values determined by the scanned bitmask may be used to define one or more joints in a skeletal model. The one or more joints are used to define one or more bones that correspond to a body part of a human.

One or more joints may be adjusted until the joints are within a range of typical distances between a joint and a body part of a human to generate a more accurate skeletal model. The model may further be adjusted based on, for example, a height associated with the human target.

At step 810, the model is tracked by updating the person's location several times per second. As the user moves in the physical space, information from the depth camera system is used to adjust the skeletal model such that the skeletal model represents a person. In particular, one or more forces may be applied to one or more force-receiving aspects of the skeletal model to adjust the skeletal model into a pose that more closely corresponds to the pose of the human target in physical space.

Generally, any known technique for tracking movements of a person can be used.

FIG. 9 depicts an example model of a human target as set forth in step 808 of FIG. 8. The model 900 is facing the depth camera, in the −z direction of FIG. 1, so that the cross-section shown is in the x-y plane. The model includes a number of reference points, such as the top of the head 902, bottom of the head or chin 913, right shoulder 904, right elbow 906, right wrist 908 and right hand 910, represented by a fingertip area, for instance. The right and left side is defined from the user's perspective, facing the camera. The model also includes a left shoulder 914, left elbow 916, left. wrist 918 and left hand 920. A waist region 922 is also depicted, along with a right hip 924, right knew 926, right foot 928, left hip 930, left knee 932 and left foot 934. A shoulder line 912 is a line, typically horizontal, between the shoulders 904 and 914. An upper torso centerline 925, which extends between the points 922 and 913, for example, is also depicted.

Accordingly, it can be seen that a depth camera system is provided which has a number of advantages. One advantage is reduced occlusions. Since a wider baseline is used, one sensor may see information that is occluded to the other sensor. Fusing of the two depth maps produces a 3D image with more observable objects compared to a map produced by a single sensor. Another advantage is a reduced shadow effect. Structured light methods inherently produce a shadow effect in locations that are visible to the sensors but are not “visible” to the light source. By applying stereoscopic matching in these regions, this effect can be reduced. Another advantage is robustness to external light. There are many scenarios where external lighting might disrupt the structured light camera, so that it is not able to produce valid results. In those cases, stereoscopic data is obtained as an additional measure since the external lighting may actually assist it in measuring the distance. Note that the external light may come from an identical camera looking at the same scene. In other words, operating two or more of the suggested cameras, looking at the same scene becomes possible. This is due to the fact that, even though the light patterns produced by one camera may disrupt the other camera from properly matching the patterns, the stereoscopic matching is still likely to succeed. Another advantage is that, using the suggested configuration, it is possible to achieve greater accuracy at far distances due to the fact that the two sensors have a wider baseline. Both structured light and stereo measurement accuracy depend heavily on the distance between the sensors/projector.

The foregoing detailed description of the technology herein has been presented for purposes of illustration and description. It is not intended to be exhaustive or to limit the technology to the precise form disclosed. Many modifications and variations are possible in light of the above teaching. The described embodiments were chosen to best explain the principles of the technology and its practical application to thereby enable others skilled in the art to best utilize the technology in various embodiments and with various modifications as are suited to the particular use contemplated. It is intended that the scope of the technology be defined by the claims appended hereto.

What is claimed is:

1. A depth camera system, comprising:
an illuminator which illuminates an object in a field of view with a pattern of structured light;
a first sensor which senses reflected light from the object to obtain a first frame of pixel data, the first sensor is optimized for shorter range imaging;
a second sensor which senses reflected light from the object to obtain a second frame of pixel data, the second sensor is optimized for longer range imaging; and
at least one control circuit, the at least one control circuit derives a first structured light depth map of the object by comparing the first frame of pixel data to the pattern of the structured light, derives a second structured light depth map of the object by comparing the second frame of pixel data to the pattern of the structured light, and derives a merged depth map which is based on the first and second structured light depth maps.

2. The depth camera system of claim 1, wherein:
a baseline distance between the first sensor and the illuminator is less than a baseline distance between the second sensor and the illuminator.

3. The depth camera system of claim 2, wherein:
an exposure time of the first sensor is shorter than an exposure time of the second sensor.

4. The depth camera system of claim 2, wherein:
a sensitivity of the first sensor is less than a sensitivity of the second sensor.

5. The depth camera system of claim 2, wherein:
a spatial resolution of the first sensor is less than a resolution of the second sensor.

6. The depth camera system of claim 1, wherein:
the second structured light depth map includes depth values; and
in deriving the merged depth map, the depth values in the second structured light depth map are weighted more heavily than depth values in the first structured light depth map.

7. A depth camera system, comprising:
an illuminator which illuminates an object in a field of view with a pattern of structured light;
a first sensor which senses reflected light from the object to obtain a first frame of pixel data;
a second sensor which senses reflected light from the object to obtain a second frame of pixel data; and
at least one control circuit, the at least one control circuit derives a merged depth map which is based on first and second structured light depth maps of the object, and at least a first stereoscopic depth map of the object, where the at least one control circuit derives the first structured light depth map of the object by comparing the first frame of pixel data to the pattern of the structured light, derives the second structured light depth map of the object by comparing the second frame of pixel data to the pattern of the structured light, and derives the at least a first stereoscopic depth map by stereoscopic matching of the first frame of pixel data to the second frame of pixel data.

8. The depth camera system of claim 7, wherein:
the at least one control circuit derives the merged depth map based on a second stereoscopic depth map of the object, where the second stereoscopic depth map is derived by stereoscopic matching of the second frame of pixel data to the first frame of pixel data.

9. The depth camera system of claim 7, wherein:
the first and second structured light depth maps and the first stereoscopic depth map include depth values; and
the at least one control circuit assigns a first set of weights to the depth values in the first structured light depth map of the object, a second set of weights to the depth values in the second structured light depth map of the object, and a third set of weights to the depth values in the first stereoscopic depth map of the object, and derives the merged depth map based on the first, second and third sets of weights.

10. The depth camera system of claim 9, wherein:
the first set of weights is assigned based on a baseline distance between the first sensor and the illuminator;
the second set of weights is assigned based on a baseline distance between the second sensor and the illuminator; and
the third set of weights is assigned based on a baseline distance between the first and second sensors.

11. The depth camera system of claim 9, wherein:
the first and third sets of weights are assigned based on a spatial resolution of the first sensor, which is different than a spatial resolution of the second sensor; and
the second set of weights is assigned based on the spatial resolution of the second sensor.

12. The depth camera system of claim 9, wherein:
the first, second and third sets of weights are assigned based on at least one of confidence measures and accuracy measures associated with the first structured light depth map, the second structured light depth map and the first stereoscopic depth map, respectively.

13. A method for processing image data in a depth camera system, comprising:
illuminating an object in a field of view with a pattern of structured light;
at a first sensor, sensing reflected light from the object to obtain a first frame of pixel data;
at a second sensor, sensing reflected light from the object to obtain a second frame of pixel data;
deriving a first structured light depth map of the object by comparing the first frame of pixel data to the pattern of the structured light, the first structured light depth map includes depth values for pixels of the first frame of pixel data;
deriving a second structured light depth map of the object by comparing the second frame of pixel data to the pattern of the structured light, the second structured light depth map includes depth values for pixels of the second frame of pixel data;
determining whether refinement of the depth values of one or more pixels of the first frame of pixel data map is desired; and
if the refinement is desired, performing stereoscopic matching of the one or more pixels of the first frame of pixel data to one or more pixels of the second frame of pixel data.

14. The method of claim 13, wherein:
the refinement is desired when the one or more pixels of the first frame of Pixel data were not successfully matched to the pattern of structured light in the comparing of the first frame of pixel data to the pattern of the structured light.

15. The method of claim 13, wherein:
the refinement is desired when the one or more pixels of the first frame of pixel data were not successfully matched to the pattern of structured light with a sufficiently high level of at least one of confidence and accuracy, in the comparing of the first frame of pixel data to the pattern of the structured light.

16. The method of claim 13, wherein:
the refinement is desired when the depth values exceed a threshold distance.

17. The method of claim 13, wherein:
a baseline distance between the first and second sensors is greater than a baseline distance between the first sensor and the illuminator, and is greater than a baseline distance between the second sensor and the illuminator.

18. The method of claim 13, wherein:
the stereoscopic matching is performed for the one or more pixels of the first frame of pixel data for which the refinement is desired, but not for one or more other pixels of the first frame of pixel data for which the refinement is not desired.

19. The method of claim 13, wherein:
if the refinement is desired, providing a merged depth map based on the stereoscopic matching and the first and second structured light depth maps.

20. The method of claim 19, further comprising:
using the merged depth map as an input to an application in a motion capture system, where the object is a human which is tracked by the motion capture system, and where the application changes a display of the motion capture system in response to a gesture or movement by the human.
